(19) United States
(12) Patent Application Publication
(10) Pub. No.: US 2014/0253822 A1
(43) Pub. Date: Sep. 11, 2014

(54) DISPLAY DEVICE INCLUDING TOUCH PANEL

(71) Applicant: SAMSUNG ELECTRO-MECHANICS CO., LTD., Suwon (KR)

(72) Inventors: Yun Ki Hong, Suwon (KR); Kyoung Soo Chae, Suwon (KR); Dong Sik Yoo, Suwon (KR); Ho Yun Cho, Suwon (KR); Hee Bum Lee, Suwon (KR); Jang Ho Park, Suwon (KR)

(21) Appl. No.: 13/921,530

(22) Filed: Jun. 19, 2013

(30) Foreign Application Priority Data
Mar. 7, 2013 (KR) 10-2013-0024537

(51) Int. Cl. G02F 1/1333

(52) U.S. Cl. CPC G02F 1/13338
USPC 349/12

(57) ABSTRACT

Disclosed herein is a display device including a touch panel including: a touch panel including a window substrate and an electrode pattern formed on one surface of the window substrate and a display unit bonded to one surface of the touch panel, wherein a stopper is formed in a spaced space between the display unit and the electrode pattern facing each other.

### CROSS REFERENCE TO RELATED APPLICATION

This application claims the benefit of Korean Patent Application No. 10-2013-0024537, filed on Mar. 7, 2013, entitled “Display Device Including Touch Panel”, which is hereby incorporated by reference in its entirety into this application.

### BACKGROUND OF THE INVENTION

1. Technical Field

The present invention relates to a display device including a touch panel.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

However, current techniques for input devices have progressed toward techniques related to high reliability, durability, innovation, designing and processing beyond the level of satisfying general functions. To this end, a touch panel has been developed as an input device capable of inputting information such as text, graphics, or the like.

In addition, the touch panel is classified into a resistive type touch panel, a capacitive type touch panel, an electromagnetic type touch panel, a surface acoustic wave (SAW) type touch panel, and an infrared type touch panel. These various types of touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

In accordance with the growth of smart apparatuses, the touch panel has been used in almost all electronic apparatuses, that is, a mobile phone, a tablet personal computer (PC), an ultra PC, a monitor, home appliances including a television (TV). According to a technology development and the intensified competition, the touch panel used in these apparatuses has been manufactured to have a high specification of performance and a thinner thickness and require a low cost in order to satisfy the demand of market.

Therefore, in order to satisfy this demand of the market, a structure of the touch panel has been changed from an existing two-layer structure to a one-layer structure, and a material thereof has been changed to a new electrode material for substituting for ITO, which is one of the rare earth metals, thereby making it possible to obtain advantages in view of a structure and a cost, as disclosed in the following prior art document (Patent Document).

However, in view of performance of the touch panel, a side effect called a touch malfunction (rear surface touch) according to a change in an interval between the touch panel and a display has occurred. That is, in the case in which pressure by a non-conductor is applied to the touch panel, a capacitance is changed according to the change in the interval between the touch panel and the display. In a touch module, a touch malfunction problem that the change in the capacitance described above is recognized as a change by a touch input of a user. This phenomenon has intensifies from a small panel to a large panel.

### PRIOR ART DOCUMENT

### Patent Document

(Patent Document 1) 2013-0013350KR

### SUMMARY OF THE INVENTION

The present invention has been made in an effort to provide a display device including a touch panel capable of securing touch reliability by forming a stopper in a spaced space between a display unit and the touch panel to prevent a change in an interval between the display unit and the touch panel.

According to a preferred embodiment of the present invention, there is provided a display device including a touch panel including: a touch panel including a window substrate and electrode patterns formed on one surface of the window substrate; a display bonded to one surface of the touch panel; and a stopper formed in a spaced space in which the display unit and the electrode patterns face each other.

An adhesive layer bonding an edge of the display unit and the touch panel to each other so that the spaced space is formed between the display unit and the touch panel.

The spaced space may have a height of 200 μm or more to 300 μm or less.

The stopper may have a height equal to or lower than that of the spaced space.

The stopper may be formed at the center on one surface of the electrode pattern.

At least one stoppers may be formed on one surface of the electrode pattern so as to be spaced apart from each other in a radial direction.

The display unit may be a liquid crystal display (LCD), a cathode ray tube (CRT), a light emitting diode (LED), or an organic light emitting diode (OLED).

According to another preferred embodiment of the present invention, there is provided a display device including a touch panel including: a touch panel including a window substrate, first electrode patterns formed in parallel with each other in one direction on a rear surface of the window substrate, a supporting layer formed on the first electrode patterns, and second electrode patterns formed on the support layer and formed in parallel with each other in a direction in which they intersect with the first electrode patterns; a display unit bonded to one surface of the touch panel; an adhesive layer bonding an edge of the display unit and the touch panel to each other so that the display unit and the second electrode patterns form a spaced space while facing each other; and a stopper formed in the spaced space.

The electrode pattern may be a mesh pattern.

The adhesive layer may have a height of 200 μm or more to 300 μm or less.

The stopper may have the same height as that of the adhesive layer.

The stopper may be formed at the center on one surface of the second electrode pattern.

At least one stoppers may be formed on one surface of the second electrode pattern so as to be spaced apart from each other in a radial direction.

The display unit may be a liquid crystal display (LCD), a cathode ray tube (CRT), a light emitting diode (LED), or an organic light emitting diode (OLED).

According to another preferred embodiment of the present invention, there is provided a display device including a touch panel including: a touch panel including a window substrate, a transparent substrate, first electrode patterns formed in parallel with each other in one direction on one surface of the transparent substrate, and second electrode patterns formed in parallel with each other in a direction in which they intersect with the first electrode patterns, on the other surface of the transparent substrate; a display unit bonded to one surface of the touch panel; an adhesive layer bonding an edge of the display unit and the touch panel to each other so that the display unit and the second electrode patterns form a spaced space while facing each other; and a stopper formed in the spaced space.

The adhesive may have a height of 200 μm or more to 300 μm or less.

The stopper may have a height equal to or lower than that of the adhesive layer.

The stopper may be formed at the center on one surface of the second electrode pattern.

At least one stoppers may be formed on one surface of the second electrode pattern so as to be spaced apart from each other in a radial direction.

The display unit may be the liquid crystal display (LCD), the cathode ray tube (CRT), the light emitting diode (LED), or the organic light emitting diode (OLED).

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view showing a display device including a touch panel according to a first preferred embodiment of the present invention;

FIGS. 2A and 2B are plan views showing a position at which a stopper according to a preferred embodiment of the present invention is formed;

FIG. 3A is a cross-sectional view showing a change in an interval between the touch panel and a display unit according to pressure of a non-conductor according to the preferred embodiment of the present invention;

FIG. 3B is a graph showing a change in a sensing signal in the case in which the pressure of the non-conductor according to the preferred embodiment of the present invention or a touch of a user is present;

FIG. 4 is a cross-sectional view showing a display device including a touch panel according to a second preferred embodiment of the present invention; and

FIG. 5 is a cross-sectional view showing a display device including a touch panel according to a third preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

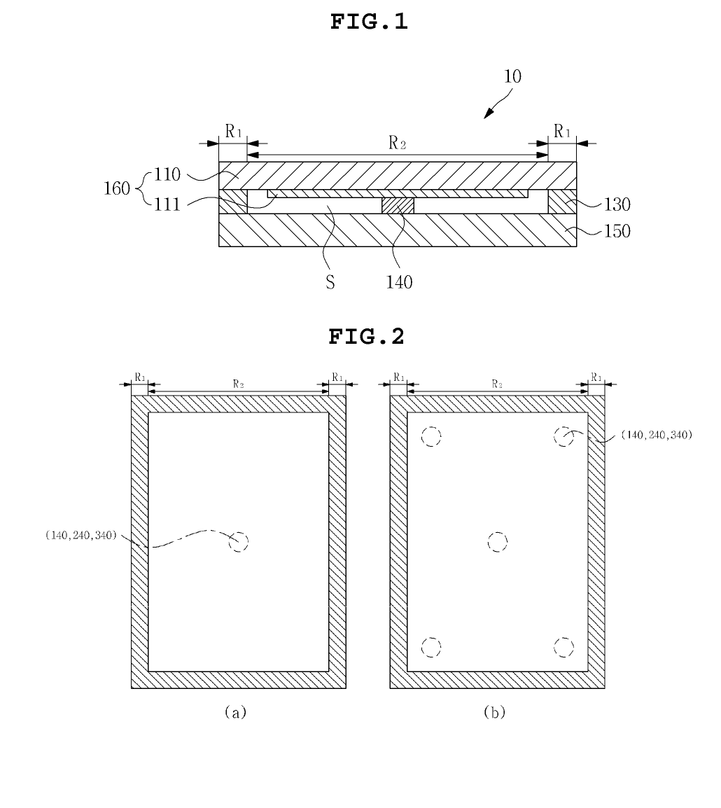

FIG. 1 is a cross-sectional view showing a display device including a touch panel according to a first preferred embodiment of the present invention. As shown in FIG. 1, the display device 10 including a touch panel according to the first preferred embodiment of the present invention is configured to include a touch panel 160 including a window substrate 110 and an electrode pattern 111 formed on one surface of the window substrate 110; a display unit 150 bonded to one surface of the touch panel 160; and a stopper 140 formed in a spaced space in which the display unit 150 and the electrode pattern 111 face each other.

The window substrate 110 may be disposed at the outermost side of the touch panel 160 to receive a touch of a user, and be made of tempered glass, or the like, to serve as a protection layer. In addition, since the electrode pattern 111 may be formed on a rear surface of the window substrate 110, high frequency treatment, primer treatment, or the like, may be performed on the rear surface of the window substrate 110 to form a surface treatment layer (not shown), in order to enhance adhesion between the window substrate 110 and the electrode pattern 111.

The electrode pattern 111 serves to generate a signal by a touch input unit to allow a touch coordinate to be recognized from a controller (not shown). Further, the electrode pattern 111 may be formed in a mesh pattern using copper (Cu), aluminum (Al), gold (Au), silver (Ag), titanium (Ti), palladium (Pd), chromium (Cr), or a combination thereof and be formed by continuously arranging at least one unit pattern (now shown). Here, the unit pattern (not shown) may have a rectangular shape, a triangular shape, a diamond shape, and other various shapes, and the electrode pattern 111 may be formed in a single-layer (bar-shaped or tooth-shaped) or two-layer (bridge-shaped or grid-shaped) structure. In addition, in order to prevent physical or chemical damage of the electrode pattern 111, a protection layer (not shown) made of an optical clear adhesive (OCA) may be formed on the electrode pattern 111.

Meanwhile, the electrode pattern 111 may also be formed using metal silver formed by exposing and developing a silver salt emulsion layer, a metal oxide such as an indium thin oxide (ITO), or the like, a conductive polymer such as poly-3, 4-ethylenedioxythiophene/polystyrenesulfonate (PEDOT/PSS), or the like, having excellent flexibility and a simple coating process, in addition to the above-mentioned metals.

The display unit 150, which is bonded to one surface of the touch panel 160 and is a display device visually outputting data on a screen, may be mainly formed of a cathode ray tube (CRT), a liquid crystal display (LCD), a plasma display panel (PDP), a light emitting diode (LED), or an organic light emitting diode (OLED), but is not necessarily limited thereto.

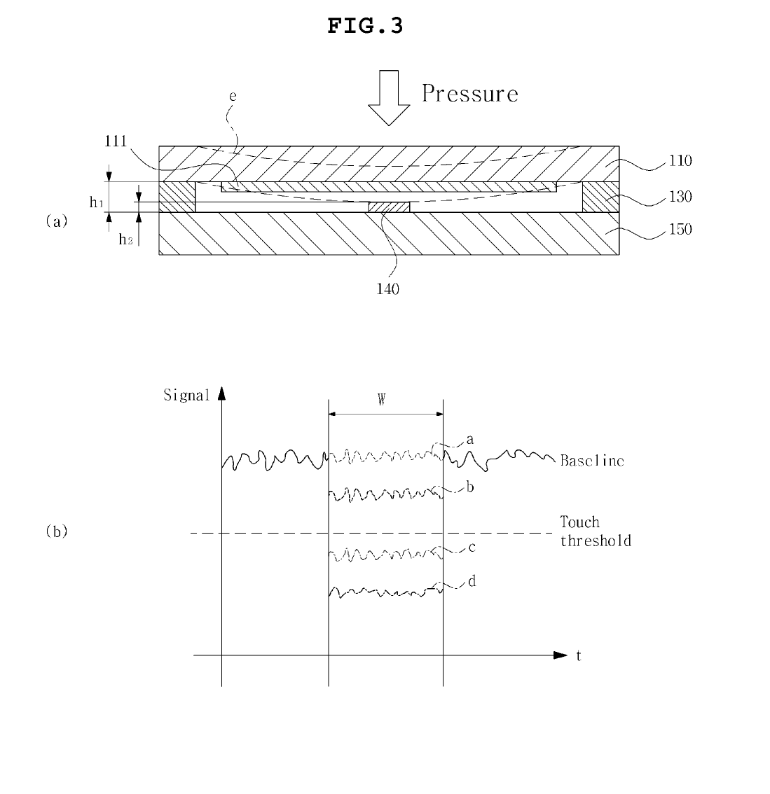

An adhesive layer 130 corresponds to a bezel area R1 and bonds an edge of the display unit 150 and the touch panel 160 to each other so that the spaced space s is formed between the display unit 150 and the touch panel 160. As a material of the adhesive layer 130, an optical clear adhesive (OCA) or a double adhesive tape (DAT) may be used. Preferably, the adhesive layer 130 may have a height h1 (see FIG. 3) of 200 μm or more to 300 μm or less.

Therefore, in the case in which the adhesive layer 130 is formed between the edge of the display unit 150 and the touch panel 160 using the double adhesive tape (DAT) so that the spaced space s is formed between the display unit 150 and the touch panel 160 as described above, light transmissivity from the display unit 150 is increased, thereby making it possible to improve user's visibility for an image.

The stopper 140 may be formed in the spaced space in which the display unit 150 and the electrode pattern 111 face each other in order to maintain an interval between the display unit 150 and the touch panel 160 to be constant and be made of an optical clear adhesive (OCA), polyethyleneterephthalate (PET), polycarbonate (PC), polymethylmethacrylate (PMMA), polyethylenenaphthalate (PEN), polyethersulfone (PES), cyclic olefin copolymer (COC), a triacetylcellulose (TAC) film, a polyvinyl alcohol (PVA) film, a polyimide (PI) film, polystyrene (PS), biaxially oriented polystyrene (BOPS; containing K resin), but is not limited thereto. That is, the stopper 140 may be made of any transparent material having rigidity enough to maintain the interval between the display unit 150 and the touch panel 160. Further, the stopper 140 may be formed on one surface of the electrode pattern 111 by a punching method, a screen printing method, or the like.

Hereinafter, a disposition structure and an acting effect of the stopper 140 formed between the display unit 150 and the touch panel 160 will be described in more detail.

FIGS. 2A and 2B are plan views showing a position at which a stopper according to a preferred embodiment of the present invention is formed. FIG. 3A is a cross-sectional view showing a change in an interval between the touch panel and a display unit according to pressure of a non-conductor according to the preferred embodiment of the present invention. FIG. 3B is a graph showing a change in a sensing signal in the case in which the pressure of the non-conductor according to the preferred embodiment of the present invention or a touch of a user is present.

The stopper 140 may be formed at the center on one surface of an electrode pattern 111 formed in a viewing area R2 of the window substrate 110 as shown in FIG. 2A. Alternatively, at least one stoppers 140 may be formed on one surface of the electrode pattern 111 so as to be spaced apart from each other in a radial direction as shown in FIG. 2B.

Due to the structure as described above, even in the case in which the pressure of the non-conductor is present, the interval s between the touch panel 160 and the display unit 150 may be maintained. In addition, the stoppers 140 are disposed in various forms according to a size of the touch panel 160 to prevent a phenomenon that the touch panel 160 warps due to use for a long period of time, thereby making it possible to improve durability of the touch panel 160.

In addition, as shown in FIG. 3A, in the case in which a height h2 of the stopper 140 is lower than the height h1 of an adhesive layer 130 (h2<h1), that is, in the case in which the pressure of the non-conductor acts on the touch panel 160, the touch panel 160 warps (e) up to the height h2 of the stopper 140, such that a capacitance is changed according to the change in the interval between the touch panel 160 and display unit 150. In this case, the touch panel 160 may erroneously recognize that an input of the user is present. In this case, whether or not the touch panel 160 recognizes the change in the capacitance according to the change in the interval between the display unit 150 and the touch panel 160 as the touch input of the user is determined according to a relationship between the height h2 of the stopper and the height h1 of the adhesive layer, which will be described below.

FIG. 3B is a graph showing a relationship between a change in a sensing signal (Baseline) and a touch input judging reference value (touch threshold) in a period w in which the pressure of the non-conductor or the touch input of the user is present. a indicates a change in a sensing signal in a state that the pressure of the non-conductor is applied to the touch panel in the case in which the height h2 of the stopper 140 is the same as the height h1 of the adhesive layer 130 (h1=h2), b indicates a change in a sensing signal in a state that the pressure of the non-conductor is applied to the touch panel in the case in which the height h2 of the stopper 140 is 80% of the height h1 of the adhesive layer 130, c indicates a change in a sensing signal in a state that the pressure of the non-conductor is applied to the touch panel in the case in which the height h2 of the stopper 140 is 30% of the height h1 of the adhesive layer 130, and d indicates a change in a sensing signal in a state that the pressure of the touch input of the user is present.

That is, i) in the case in which the height h2 of the stopper 140 is 80% of the height h1 of the adhesive layer 130(b), even though the pressure of the non-conductor is applied to the touch panel 160, since the sensing signal (Baseline) does not fall to the touch input judging reference value (Touch threshold) or less, the touch panel 160 does not recognize the pressure of the non-conductor as the touch input of the user.

However, ii) in the case in which the height h2 of the stopper 140 is 30% of the height h1 of the adhesive layer 130, when the pressure of the non-conductor is applied to the touch panel 160, since the sensing signal (Baseline) falls to the touch input judging reference value (Touch threshold) or less, the touch panel 160 recognizes the pressure by the non-conductor as the touch input of the user.

Here, in the case in which the heights of the stopper 140 and the adhesive layer 130 are the same as each other (h1=h2), the stopper 140 formed on one surface of the touch panel 160 serves as a supporter. Therefore, even though the pressure of the non-conductor is applied to the touch panel 160, since the change in the interval between the touch panel 160 and the display unit 150 is not generated, such that a malfunction problem of the touch panel 160 due to a rear surface touch is not generated.

Even though the heights of the stopper 140 and the adhesive layer 130 are not the same as each other (h1≠h2) (b and c), in the case in which the pressure of the non-conductor is applied to the touch panel 160, the height h2 of the stopper 140 is adjusted so that the sensing signal (Baseline) does not fall to a set value or less of the touch input judging reference value (touch threshold), thereby making it possible to prevent the malfunction of the touch panel 160 according to the change in the interval between the touch panel 160 and the display unit 150.

As described above, the display device 10 including a touch panel prevents the change in the capacitance according to the change in the interval between the display unit 150 and the touch panel 160 through the stopper 140 formed in the spaced space s between the display unit 150 and the touch panel 160, thereby making it possible to prevent the malfunction of the touch panel 160.

In addition, the stoppers 140 are disposed in various forms according to the size of the touch panel 160 to prevent the phenomenon that the touch panel 160 warps due to the use for a long period of time, thereby making it possible to improve durability of the touch panel 160.

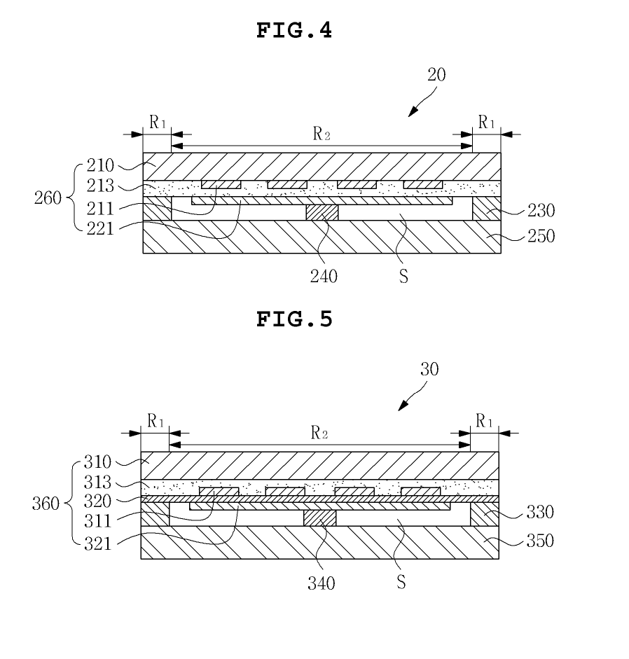

FIG. 4 is a cross-sectional view showing a display device including a touch panel according to a second preferred embodiment of the present invention; and FIG. 5 is a cross-sectional view showing a display device including a touch panel according to a third preferred embodiment of the present invention.

A window substrate 210 or 310, first and second electrode patterns 211 and 221 or 311 and 321, an adhesive layer 230 or 330, a stopper 240 or 340, and a display unit 250 or 350 have the same technical feature as that of the window substrate 110, the electrode pattern 111, the adhesive layer 130, the stepper 140, and the display unit 150, that is, a technical feature for preventing a malfunction of a touch panel 260 or 360 according to a change in an interval of a spaced space s by forming the stopper 240 or 340 in the spaced space s between the touch panel 260 or 360 and the display unit 250 or 350. Therefore, since a detailed description of the respective components and a relationship therebetween is overlapped with that of the components corresponding to the first preferred embodiment of the present invention, it will be omitted.

As shown in FIG. 4, the display device including a touch panel according to the second embodiment of the present invention is configured to include a touch panel 260 including a window substrate 210, first electrode patterns 211 formed in parallel with each other in one direction on a rear surface of the window substrate 210, a supporting layer 213 formed on the first electrode patterns 211, and second electrode patterns 221 formed on the supporting layer 213 and formed in parallel with each other in a direction in which they intersect with the first electrode patterns 211; a display unit 250 bonded to one surface of the touch panel 260; an adhesive layer 230 bonding an edge of the display unit 250 and the touch panel 260 to each other so that the display unit 250 and the second electrode patterns 221 form a spaced space s while facing each other; and a stopper 240 formed in the spaced space s.

Here, the supporting layer 213 may be formed on the first electrode patterns 211 using an organic or inorganic insulating material by a dry coating method such as a sputtering method, or the like, and a wet coating method such as an imprinting method using a droplet, a printing method, or the like. As the insulating material, a transparent material is preferably used so as not to hinder the user from recognizing an image output from the display unit 250, and all organic or inorganic films for passivation (a heat or ultraviolet (UV) curable material, an oxide such as SiO2, a nitride, or the like) may be used.

As shown in FIG. 5, the display device including a touch panel according to the third embodiment of the present invention is configured to include a touch panel 360 including a window substrate 310, a transparent substrate 320, first electrode patterns 311 formed in parallel with each other in one direction on one surface of the transparent substrate 320, and second electrode patterns 321 formed in parallel with each other in a direction in which they intersect with the first electrode patterns 311, on the other surface of the transparent substrate 320; a display unit 350 bonded to one surface of the touch panel 360; an adhesive layer 330 bonding an edge of the display unit 350 and the touch panel 360 to each other so that the display unit 350 and the second electrode patterns 321 form a spaced space s while facing each other; and a stopper 340 formed in the spaced space s.

Here, an insulating layer 313, which serves to bond the window substrate 310 and the first electrode patterns 311 to each other, is preferably made of a transparent material so as not to hinder the user from recognizing an image output from the display unit 350, for example, an optical clear adhesive (OCA).

As described above, the display units 20 or 30 including a touch panel according to the second or third preferred embodiment of the present invention prevents the change in the capacitance according the change in the interval between the display unit 250 or 350 and the touch panel 260 or 360 through the stopper 240 or 340 formed in the spaced space s between the touch panel 260 or 360 and the display unit 250 or 350, thereby making it possible to prevent the malfunction of the touch panel 260 or 360.

In addition, the stoppers 240 or 340 are disposed in various forms according to the size of the touch panel 260 or 360 to prevent the phenomenon that the touch panel 260 or 360 warps due to the use for a long period of time, thereby making it possible to improve durability of the touch panel 260 or 360.

According to the preferred embodiments of the present invention, the stopper is formed in the spaced space between the display unit and the touch panel to prevent the touch malfunction according to the change in the interval between the display unit and the touch panel, thereby making it possible to ensure reliability of the touch panel.

Further, the stoppers are disposed in various forms according to the size of the touch panel to prevent the phenomenon that the touch panel warps due to the use for a long period of time, thereby making it possible to improve the durability of the touch panel.

Furthermore, the adhesive layer is formed between the edge of the display unit and the touch panel so that the spaced space is formed between the touch panel and the display unit, such that the light transmittance for the image output to the display unit increases, thereby making it possible to improve the user's visibility for the image.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims

What is claimed is:

1. A display device including a touch panel, comprising:
a touch panel including a window substrate and electrode patterns formed on one surface of the window substrate;
a display unit bonded to one surface of the touch panel; and
a stopper formed in a spaced space in which the display unit and the electrode patterns face each other.

2. The display device as set forth in claim 1, further comprising an adhesive layer bonding an edge of the display unit and the touch panel to each other so that the spaced space is formed between the display unit and the touch panel.

3. The display device as set forth in claim 1, wherein the spaced space has a height of 200 μm or more to 300 μm or less.

4. The display device as set forth in claim 1, wherein the stopper has a height equal to or lower than that of the spaced space.

5. The display device as set forth in claim 1, wherein the stopper is formed at the center on one surface of the electrode pattern.

6. The display device as set forth in claim 1, wherein at least one stoppers are formed on one surface of the electrode pattern so as to be spaced apart from each other in a radial direction.

7. The display device as set forth in claim 1, wherein the display unit is a liquid crystal display (LCD), a cathode ray tube (CRT), a light emitting diode (LED), or an organic light emitting diode (OLED).

8. A display device including a touch panel, comprising:
a touch panel including a window substrate, first electrode patterns formed in parallel with each other in one direction on a rear surface of the window substrate, a supporting layer formed on the first electrode patterns, and second electrode patterns formed on the support layer and formed in parallel with each other in a direction in which they intersect with the first electrode patterns;
a display unit bonded to one surface of the touch panel;
an adhesive layer bonding an edge of the display unit and the touch panel to each other so that the display unit and the second electrode patterns form a spaced space while facing each other; and
a stopper formed in the spaced space.

9. The display device as set forth in claim 8, wherein the electrode pattern is a mesh pattern.

10. The display device as set forth in claim 8, wherein the adhesive has a height of 200 μm or more to 300 μm or less.

11. The display device as set forth in claim 8, wherein the stopper has the same height as that of the adhesive layer.

12. The display device as set forth in claim 8, wherein the stopper is formed at the center on one surface of the second electrode pattern.

13. The display device as set forth in claim 8, wherein at least one stoppers are formed on one surface of the second electrode pattern so as to be spaced apart from each other in a radial direction.

14. The display device as set forth in claim 8, wherein the display unit is a liquid crystal display (LCD), a cathode ray tube (CRT), a light emitting diode (LED), or an organic light emitting diode (OLED).

15. A display device including a touch panel, comprising:
a touch panel including a window substrate, a transparent substrate, first electrode patterns formed in parallel with each other in one direction on one surface of the transparent substrate, and second electrode patterns formed in parallel with each other in a direction in which they intersect with the first electrode patterns, on the other surface of the transparent substrate;
a display unit bonded to one surface of the touch panel;
an adhesive layer bonding an edge of the display unit and the touch panel to each other so that the display unit and the second electrode patterns form a spaced space while facing each other; and
a stopper formed in the spaced space.

16. The display device as set forth in claim 15, wherein the adhesive has a height of 200 μm or more to 300 μm or less.

17. The display device as set forth in claim 15, wherein the stopper has a height equal to or lower than that of the adhesive layer.

18. The display device as set forth in claim 15, wherein the stopper is formed at the center on one surface of the second electrode pattern.

19. The display device as set forth in claim 15, wherein at least one stoppers are formed on one surface of the second electrode pattern so as to be spaced apart from each other in a radial direction.

20. The display device as set forth in claim 15, wherein the display unit is a liquid crystal display (LCD), a cathode ray tube (CRT), a light emitting diode (LED), or an organic light emitting diode (OLED).
